(19) United States
(12) Patent Application Publication
(10) Pub. No.: US 2012/0235923 A1
(43) Pub. Date: Sep. 20, 2012

(54) ELECTRONIC DEVICE SYSTEM WITH NOTES AND METHOD OF OPERATION THEREOF

(75) Inventor: Satoshi Araki, San Jose, CA (US)

(73) Assignee: SONY CORPORATION, Tokyo (JP)

(21) Appl. No.: 13/047,793

(22) Filed: Mar. 15, 2011

(51) Int. Cl. G06F 3/041

(52) U.S. Cl. 345/173

(57) ABSTRACT

A method of operation of an electronic device system includes: providing a display interface; monitoring a screen pointer in direct contact with the display interface; detecting a raw movement having movement deviations on the display interface with the screen pointer for forming a geometric shaped area; generating a path based on the raw movement and compensated for movement deviations in the raw movement to define a perimeter of the geometric shaped area; generating a graphical area having a geometric shape defined by the path; and displaying the graphical area in the display interface.

### TECHNICAL FIELD

The present invention relates generally to a display system, and more particularly to a system for notations.

### BACKGROUND ART

This relates to electronic devices and, more particularly, to touch sensitive displays for electronic devices. Electronic devices such as cellular telephones, handheld computers, and portable music players often include displays. A display includes an array of controllable pixels that are used to present visual information to a user. To protect a display from damage, the display may be mounted behind a protective layer of cover glass. The active portion of a display may be formed using backlit liquid crystal display (LCD) technology. Displays may also be formed using pixels based on organic light-emitting diode (OLED) technology.

It is often desirable to provide displays with touch sensor capabilities. For example, personal digital assistants have been provided with touch screens using resistive touch sensing technology. Touch screens of this type have a pair of opposing flexible plastic panels with respective sets of transparent electrodes. When touched by an object, the upper panel flexes into contact with the lower panel. This forces opposing electrodes into contact with each other and allows the location of the touch event to be detected.

Resistive touch screens can have undesirable attributes such as position-dependent sensitivity. Accordingly, many modern touch screens employ touch sensors based on capacitance sensing technology. In a capacitive touch screen, a capacitive touch sensor is implemented using an array of touch sensor electrodes. When a finger of a user or other external object is brought into the vicinity of the touch sensor electrodes, corresponding capacitance changes can be sensed and converted into touch location information.

In conventional capacitive touch screens, capacitive electrodes are formed on a glass substrate. The glass substrate is interposed between the active portion of the display and an outer cover glass. Although efforts are made to ensure that the glass substrate on which the capacitive electrodes are formed is not too thick, conventional glass substrates may still occupy about half of a millimeter in thickness. Particularly in modern devices in which excessive overall device thickness is a concern, the glass substrate thickness that is associated with conventional capacitive touch sensors can pose challenges.

The use of touch sensitive surfaces as input devices for computers and other electronic devices has increased significantly in recent years. It would therefore be desirable to be able to provide improved usability, reliability, and accuracy of touch sensitive screens for electronic devices.

Thus, a need remains for a display system with an improved transportation mechanism to provide benefits of minimized costs and to maximize efficiency while improving reliability, safety, or handling of the people or merchandise. In view of the ever increasing social and economic transportation needs of the world, it is increasingly critical that answers be found to these problems.

In view of growing consumer expectations, an improved system for movement of people or goods in a timely manner are highly sought after it is critical that answers be found for these problems. Additionally, the need to reduce costs, improve efficiencies and performance, and meet competitive pressures adds an even greater urgency to the critical necessity for finding answers to these problems. Solutions to these problems have been long sought but prior developments have not taught or suggested any solutions and, thus, solutions to these problems have long eluded those skilled in the art.

### DISCLOSURE OF THE INVENTION

The present invention provides a method of operation of an electronic device system including: providing a display interface; monitoring a screen pointer in direct contact with the display interface; detecting a raw movement having movement deviations on the display interface with the screen pointer for forming a geometric shaped area; generating a path based on the raw movement and compensated for movement deviations in the raw movement to define a perimeter of the geometric shaped area; generating a graphical area having a geometric shape defined by the path; and displaying the graphical area in the display interface.

The present invention provides an electronic device system, including: a user interface for providing a display interface; a screen path module for monitoring a screen pointer in direct contact with the display interface; a vector adjustment module for detecting a raw movement having movement deviations on the display interface with the screen pointer for forming a geometric shaped area; a path build module coupled to the vector adjust module for generating a path based on the raw movement and compensated for movement deviations in the raw movement to define a perimeter of the geometric shaped area; a control unit coupled to the path build module for generating a graphical area having a geometric shape defined by the path; and a screen presentation module for displaying the graphical area in the display interface.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is an electronic device system with a display mechanism in a first embodiment of the present invention.

FIG. 2 is an example of a display interface of the first device.

FIG. 3 is the example of FIG. 2 in a gesture presentation mode.

FIG. 4 is a further example of the display interface of the first device.

FIG. 5 is the further example of FIG. 4 in a gesture presentation mode.

FIG. 6 is an exemplary block diagram of the first device.

FIG. 7 is an exemplary block diagram of an electronic device system with a gesture processing mechanism in a second embodiment of the present invention.

FIG. 8 is an exemplary block diagram of an electronic device system with a gesture processing mechanism in a third embodiment of the present invention.

FIG. 9 is a flow chart of a method of operation of an electronic device system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGs. Similarly, although the views in the drawings for ease of description generally show similar orientations, this depiction in the FIGs. is arbitrary for the most part. Generally, the invention can be operated in any orientation. The embodiments have been numbered first embodiment, second embodiment, etc. as a matter of descriptive convenience and are not intended to have any other significance or provide limitations for the present invention.

The term “module” referred to herein, can include software, hardware, or a combination thereof. For example, the software can be machine code, firmware, embedded code, and application software. Also for example, the hardware can be circuitry, processor, computer, integrated circuit, integrated circuit cores, a pressure sensor, an inertial sensor, a micro electro mechanical system (MEMS), passive devices, or a combination thereof.

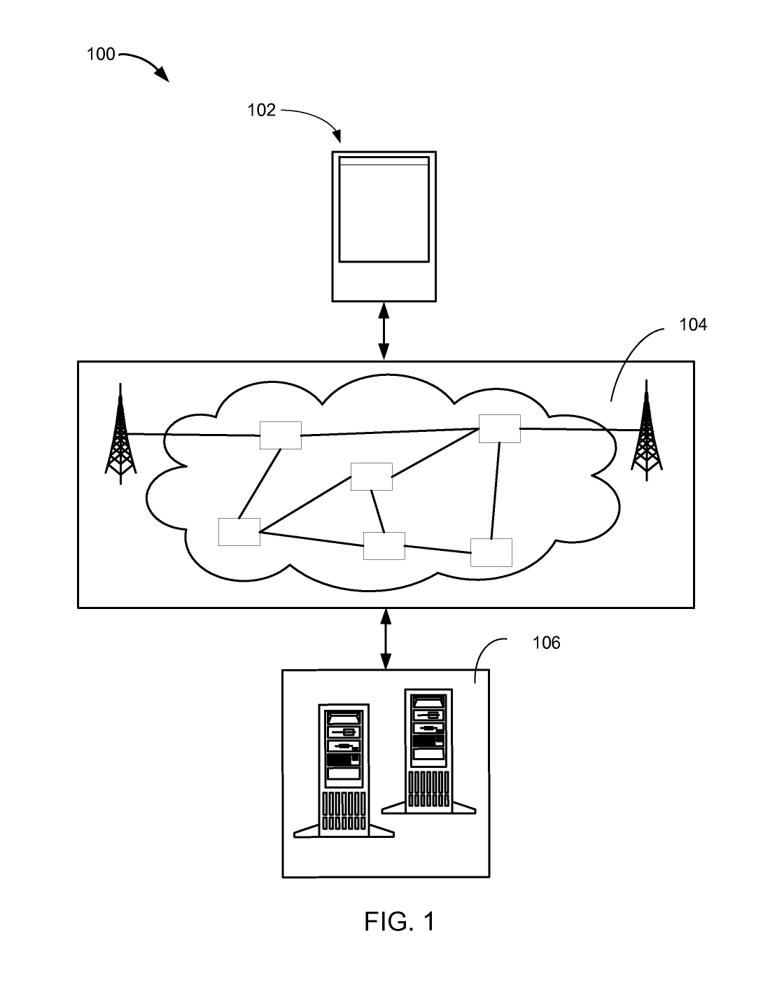

Referring now to FIG. 1, therein is shown an electronic device system 100 with a display mechanism in a first embodiment of the present invention. The electronic device system 100 includes a first device 102 having a touch sensitive display, such as a digital reader, a personal digital assistant, a handheld electronic device or incorporated with an electronic system, for example, an entertainment system, a client, a server, or a micro-processor based system. The first device 102 can couple to a communication path 104, such as a wireless or wired network used for communication with other devices.

For illustrative purposes, the electronic device system 100 is described with a second device 106 such as a device similar to the first device 102 or a non-mobile computing device. It is understood that the second device 106 can be a different type of electronic device. For example, the second device 106 can also be a mobile computing device, such as notebook computer or a different type of client device.

Also for illustrative purposes, the electronic device system 100 is shown with the second device 106 and the first device 102 as end points of the communication path 104, although it is understood that the electronic device system 100 can have a different partition between the first device 102, the second device 106, and the communication path 104. For example, the first device 102, the second device 106, or a combination thereof can also function as part of the communication path 104.

The communication path 104 can be a variety of networks. For example, the communication path 104 can include wireless communication, wired communication, optical, ultrasonic, or the combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104.

Further, the communication path 104 can traverse a number of network topologies and distances. For example, the communication path 104 can include direct connection, personal area network (PAN), local area network (LAN), metropolitan area network (MAN), wide area network (WAN) or any combination thereof.

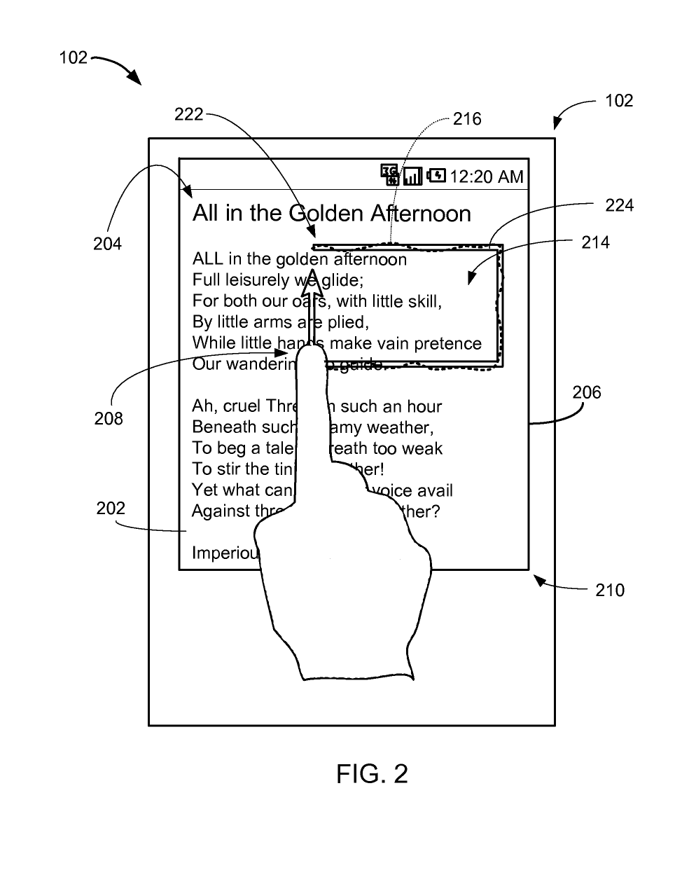

Referring now to FIG. 2, therein is shown an example of a display interface 202 of the first device 102. The display interface 202 includes a touch sensitive display screen used to show display information 204, such as text, symbols, photos, or graphical data, within a display perimeter 206 of the display interface 202. The touch sensitive display screen can be of a variety of screen display technologies including an electronic paper display (EPD), a liquid crystal display (LCD), an organic light emitting diode (OLED), or of any screen display technology having touch sensitive display capabilities.

An array of contact sensors (not shown) can be distributed within the display perimeter 206 to detect gestures or monitor movements from a presence, an absence, or a movement of a screen pointer 208, such as a finger, stylus, or a blunt tipped object, in the display perimeter 206 and in direct contact with the touch sensitive display screen of the display interface 202.

The contact sensors within the array can individually be formed having a uniform size and spacing from one another to monitor or provide sensor location information, such as the presence or absence of the screen pointer 208 relative to coordinate positions 210 on the display perimeter 206. The coordinate positions 210 can include an upper left corner, an upper right corner, a lower left corner, a lower right corner, any point, or combinations thereof on the display perimeter 206.

Two of the contact sensors adjacent to one another without any other of the contact sensors positioned directly between the two contact sensors can be referred to as a sensor pair. Two of the contact sensors or two of the sensor pairs adjacent to one another without any other of the contact sensors positioned directly between the two of the contact sensors or the two sensor pairs, respectively, can be referred to as a sensor segment.

Directional movement of the screen pointer 208 can be monitored or determined when the contact sensors of several of the sensor segments sequentially detect and indicate the presence and absence of the screen pointer 208. The movement of the screen pointer 208 in direct contact with the touch sensitive display screen of the display interface 202 can used to define a size, shape, and location of a geometric shaped area 214 in the display perimeter 206.

For illustrative purposes, the screen pointer 208 shown and described defining the geometric shaped area 214 having a rectangular shape. The screen pointer 208 can be used to define other shaped areas. For example, the screen pointer 208 can be used to define the other shaped areas that can include polygons having curved sides, straight sides, or side combinations thereof. It is noted that description and concepts of the present embodiment can be applied to the other shaped areas as well.

The movement of the screen pointer 208 detected directly by the contact sensors can be defined as a raw movement 216 (shown with dashed lines). The raw movement 216 can include an initial detection of the screen pointer 208 at a home position 222 and either a continuous clockwise or counter-clockwise movement of the screen pointer 208 back to the home position 222. The screen pointer 208 can be in continued direct contact with the touch sensitive display screen of the display interface 202.

Rotational reversals are defined as a detected change in movement of the screen pointer 208 from a clockwise to a counter-clockwise movement or from a counter-clockwise to clockwise movement by hardware or software of the first device 102. The rotational reversals can be either compensated to correct the rotational reversals or rejected as an error by the first device 102.

The home position 222 can be used to start, end, and validate the formation of an outlined shape or of the geometric shaped area 214. The raw movement 216 is validated after the screen pointer 208 has returned to a pre-defined distance from the contact sensors located at the home position 222. The screen pointer 208 should remain in contact with the touch sensitive display screen throughout the raw movement 216. The first device 102 could optionally be configured to invalidate the raw movement 216 as a result of momentary separation of the screen pointer 208 from the touch sensitive display screen.

For illustrative purposes, the raw movement 216 is shown forming an outlined shape similar to a rectangle with wavy sides and curved shaped corners. Movement deviations in the raw movement 216 forming the outlined shape can include vertical deviation movements or horizontal deviation movements detected by the hardware or the software. The vertical deviation movements are defined as the detection of non-vertical movements following a vertical movement.

The horizontal deviation movements are defined as the detection of non-horizontal movements following a horizontal movement. The first device 102 can be configured using circuitry or software to compensate for the vertical deviation movements or the horizontal deviation movements of the raw movement 216 to provide a path 224 defining the perimeter of the geometric shaped area 214.

Real time data processing is defined as a process whereby received data can be analyzed and used to generate new information as soon as the data are available. Delayed processing is defined as a process whereby received data can be analyzed only after predetermined portions defining a shape of the received data have been received.

The first device 102 can analyze and process information with real time data processing. The first device 102 analyzes and processes the information as received from the contact sensors to generate parameters used to adjust or compensate the raw movement 216 and form the geometric shaped area 214. Non-linear sides or curved shaped corners of the raw movement 216 can be corrected using circuitry or software to form the geometric shaped area 214 having straight sides and right angled shaped corners.

For illustrative purposes, the geometric shaped area 214 is shown as a rectangle having a height less than a width. The geometric shaped area 214 can have a different geometric shape or dimension. For example, the geometric shaped area 214 could have a shape of a triangle, a circle, a pentagon, or of any polygon.

It has been discovered that the generation of parameters using real time data processing techniques to adjust or compensate the raw movement 216 and to produce the path 224 is faster than other touch sensitive devices that use delayed processing techniques and rely on gestures, patterns, stored data, or stored patterns that have been predetermined, previously stored, or preprogrammed.

It has also been discovered that the generation of parameters using real time data processing techniques to adjust or compensate deviations of the raw movement 216 produces improved accuracy and rendition of the geometric shaped area 214 over typical touch sensitive devices. The deviations such as irregular, shaken, or random movements using the real time data processing techniques of the present invention are particularly effective over the typical touch sensitive devices that use delayed processing techniques and rely on gestures, patterns, stored data, or stored patterns that have been predetermined, previously stored, or preprogrammed.

It has further been discovered that the path 224 fits the raw movement 216 and eliminates the delayed processing techniques or reliance on gestures, patterns, stored data, or stored patterns that have been predetermined, previously stored, or preprogrammed.

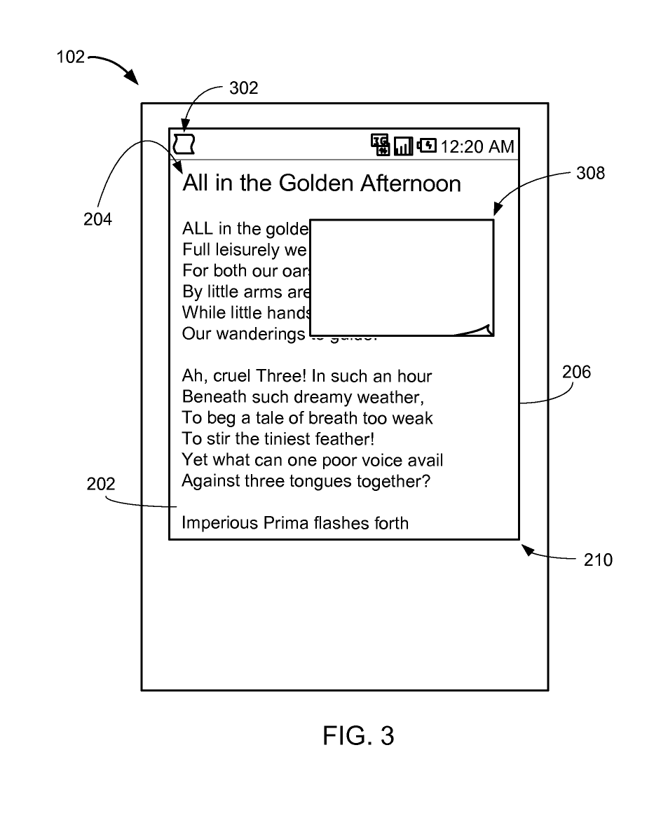

Referring now to FIG. 3, therein is shown the example of FIG. 2 in a gesture presentation mode. A notation symbol 302 can optionally be displayed in the touch sensitive display screen of the display interface 202 to indicate that a graphical area 308 has been successfully generated.

The graphical area 308 having a geometric shape and size can be defined by the path 224 of FIG. 2 can be opaque, semi-opaque, or any combination thereof. The graphical area 308 can be located at the same location as the geometric shaped area 214 of FIG. 2 and with respect to the coordinate positions 210. The graphical area 308 can be displayed over the display information 204 shown in the touch sensitive display screen of the display interface 202 and optionally be tinted in colors or shades that are supported by technology of the touch sensitive display screen.

The graphical area 308 can optionally include graphical content (not shown) similar to the display information 204 that can include text, symbols, icons, graphical images, or any combination thereof. The graphical area 308 can remain fixed at the location of the geometric shaped area 214, positioned over a specific portion of the display information 204, moved to a different location over the display information 204, or moved fully or partially out from view within the display perimeter 206 to expose the display information 204.

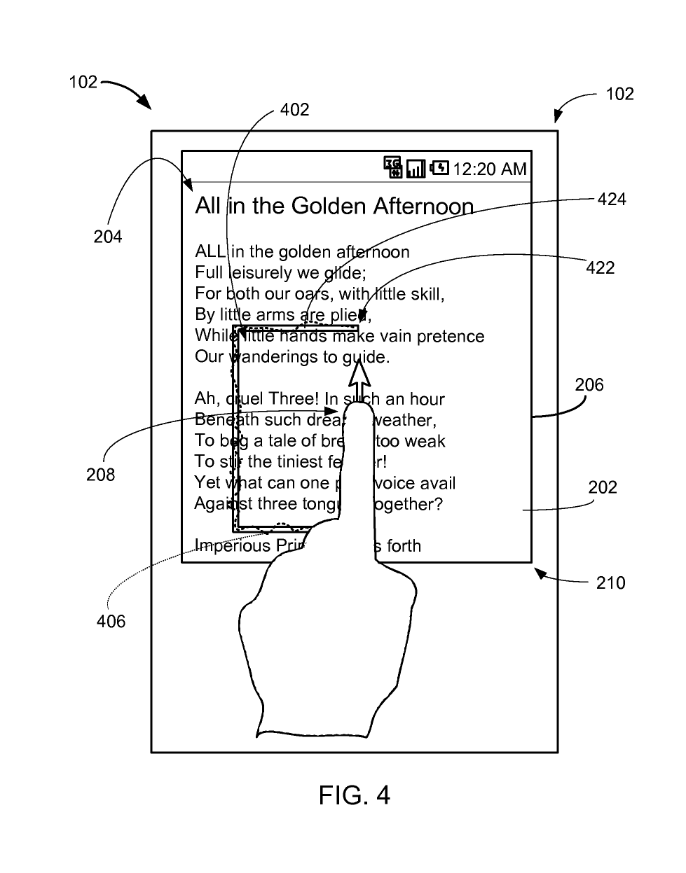

Referring now to FIG. 4, therein is shown a further example of the display interface 202 of the first device 102. The touch sensitive display screen of the display interface 202 is shown with the display information 204 within the display perimeter 206. An array of contact sensors (not shown) can be distributed within the display perimeter to detect gestures or monitor movements from a presence, an absence, or a movement of the screen pointer 208 in the display perimeter 206 and in direct contact with the touch sensitive display screen of the display interface 202.

Directional movement of the screen pointer 208 can be monitored or determined when the contact sensors of several of the sensor segments sequentially detect and indicate the presence and absence of the screen pointer 208. The movement of the screen pointer 208 in direct contact with the touch sensitive display screen of the display interface 202 can used to define a size, shape, and location of a geometric shaped area 402 in the display perimeter 206.

For illustrative purposes, the screen pointer 208 shown and described defining the geometric shaped area 402 having a rectangular shape. The screen pointer 208 can be used to define other shaped areas. For example, the screen pointer 208 can be used to define the other shaped areas that can include polygons having curved sides, straight sides, or side combinations thereof. It is noted that description and concepts of the present embodiment can be applied to the other shaped areas as well.

The movement of the screen pointer 208 monitored or detected directly by the contact sensors can be defined as a raw movement 406 (shown with dashed lines). The raw movement 406 can include an initial detection of the screen pointer 208 at a home position 422 and either a continuous geometric clockwise or counter-clockwise movement of the screen pointer 208 back to the home position 422.

Rotational reversals are defined as a detected change in movement of the screen pointer 208 from a geometric clockwise to a geometric counter-clockwise movement or from a geometric counter-clockwise to geometric clockwise movement by hardware or software of the first device 102. The rotational reversals can be either compensated to correct the rotational reversals or rejected as an error by the first device 102.

The home position 422 can be used to start, end, and validate the formation of an outlined shape or the geometric shaped area 402. The raw movement 406 is validated after the screen pointer 208 has returned to a pre-defined distance from the contact sensors located at the home position 422. The screen pointer 208 should remain in contact with the touch sensitive display screen throughout the raw movement 406. The first device 102 could optionally be configured to invalidate the raw movement 406 as a result of momentary separation of the screen pointer 208 from the touch sensitive display screen.

For illustrative purposes, the raw movement 406 is shown forming an outlined shape similar to a rectangle with wavy sides and curved shaped corners. Movement deviations in the raw movement 406 forming the outlined shape can include vertical deviation movements or horizontal deviation movements by the hardware or the software. The vertical deviation movements are defined as the detection of non-vertical movements following a vertical movement.

The horizontal deviation movements are defined as the detection of non-horizontal movements following a horizontal movement. The first device 102 can be configured to compensate for the vertical deviation movements or the horizontal deviation movements of the raw movement 406 to provide a path 424 defining the perimeter of the geometric shaped area 402.

Real time data processing is defined as a process whereby received data can be analyzed and used to generate new information as soon as the data are available. Delayed processing is defined as a process whereby received data be analyzed only after predetermined portions defining a shape of the received data have been received.

The first device 102 can analyze and process information with real time data processing. The first device 102 analyzes and processes the information as received from the contact sensors to generate parameters used to adjust or compensate the raw movement 406 and form the geometric shaped area 402. Non-linear sides or curved shaped corners of the raw movement 406 can be corrected to form the geometric shaped area 402 having straight sides and right angled shaped corners.

For illustrative purposes, the geometric shaped area 402 is shown as a rectangle having a width less than a height. The geometric shaped area 402 can have a different geometric shape or dimension. For example, the geometric shaped area 402 can have a shape of a square or a height less than a width.

It has been discovered that the generation of parameters using real time data processing techniques to adjust or compensate the raw movement 406 and to produce the path 424 is faster than other touch sensitive devices that use delayed processing techniques and rely on gestures, patterns, stored data, or stored patterns that have been predetermined, previously stored, or preprogrammed.

It has also been discovered that the generation of parameters using real time data processing techniques to adjust or compensate deviations of the raw movement 406 produces improved accuracy and rendition of the geometric shaped area 402 over typical touch sensitive devices. The deviations such as irregular, shaken, or random movements using the real time data processing techniques of the present invention are particularly effective over the typical touch sensitive devices that use delayed processing techniques and rely on gestures, patterns, stored data, or stored patterns that have been predetermined, previously stored, or preprogrammed.

It has further been discovered that the path 424 fits the raw movement 406 and eliminates the delayed processing techniques or reliance on gestures, patterns, stored data, or stored patterns that have been predetermined, previously stored, or preprogrammed.

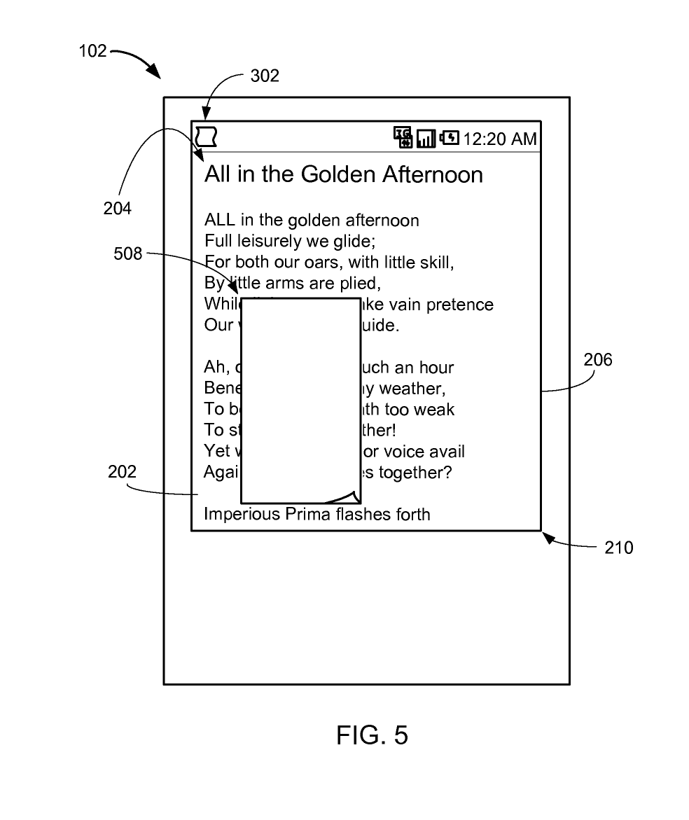

Referring now to FIG. 5, therein is shown the further example of FIG. 4 in a gesture presentation mode. The notation symbol 302 can optionally be shown in the touch sensitive display screen of the display interface 202 to indicate that a graphical area 508 has been successfully generated.

The graphical area 508 having a geometric shape and size can be defined by the path 424 of FIG. 4 can be opaque, semi-opaque, or any combination thereof. The graphical area 508 can be located at the same location as the geometric shaped area 402 of FIG. 4 and with respect to the coordinate positions 210. The graphical area 508 can be displayed over the display information 204 shown in the touch sensitive display screen of the display interface 202 and optionally be tinted in colors or shades that are supported by technology of the touch sensitive display screen.

The graphical area 508 can optionally include graphical content (not shown) similar to the display information 204 that can include text, symbols, icons, graphical images, or any combination thereof. The graphical area 508 can remain fixed at the location of the geometric shaped area 402, positioned over a specific portion of the display information 204, moved to a different location over the display information 204, or moved fully or partially out from view within the display perimeter 206 to expose the display information 204.

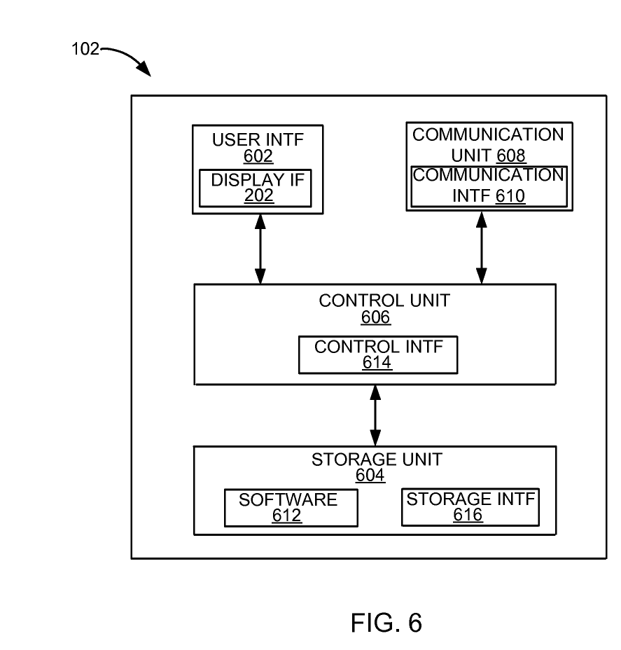

Referring now to FIG. 6, therein is shown an exemplary block diagram of the first device 102. The first device 102 includes functional units that can include a user interface 602, a storage unit 604, a control unit 606, and a communication unit 608.

The touch sensitive display screen of the display interface 202 allows a user (not shown) to interface and interact with the first device 102. The touch sensitive display screen of the display interface 202 can be used to display the display information 204 of FIG. 2 to the user from the first device 102. The contact sensors can provide the user interface 602 with the user input such as instructions, commands, or data from the screen pointer 208 of FIG. 2.

The communication unit 608 can provide external communications to or from the first device 102. For example, the communication unit 608 can permit the first device 102 to communicate with the second device 106 of FIG. 1, the communication path 104 of FIG. 1, or an attachment (not shown) such as a peripheral device or a computer desktop.

The communication unit 608 can also function as a communication hub allowing the first device 102 to function as part of the communication path 104 and not be functionally limited to operate as an end point or a terminal unit to the communication path 104. The communication unit 608 can include active and passive components, such as microelectronics or an antenna, for interaction with the communication path 104.

The communication unit 608 can include a communication interface 610. The communication interface 610 can be used for communication between the communication unit 608 and another of the functional units in the first device 102 or external units (not shown) outside the first device 102. The communication interface 610 can receive information from or transmit information to another of the functional units.

The communication interface 610 can be implemented in different ways that depend on which of the functional units or the external units are being interfaced with the communication interface 610. For example, the communication interface 610 can be implemented with a pressure sensor, an inertial sensor, a microelectromechanical system (MEMS), optical circuitry, waveguides, wireless circuitry, wireline circuitry, or a combination thereof.

The control unit 606 can execute software 612 to provide functional and operational intelligence to the electronic device system 100. The control unit 606 can operate the user interface 602 to display information generated by the electronic device system 100. The control unit 606 can further execute the software 612 for interaction with the communication path 104 of FIG. 1 via the communication unit 608.

The control unit 606 can be implemented in a number of different manners. For example, the control unit 606 can be a processor, an embedded processor, a microprocessor, a hardware control logic, a hardware finite state machine (FSM), a digital signal processor (DSP), or a combination thereof.

The control unit 606 can include a controller interface 614. The controller interface 614 can be used for communication between the control unit 606 and another of the functional units in the first device 102. External sources (not shown) and external destinations (not shown) refer to sources and destinations external to the first device 102.

The controller interface 614 can also be used for communication between the first device 102 and the external sources. The controller interface 614 can receive information from another of the functional units or from the external sources, or can transmit information to another of the functional units or to the external destinations.

The controller interface 614 can include different implementations depending on which of the functional units are being interfaced with the control unit 606. The controller interface 614 can be implemented with technologies and techniques similar to the implementation of the communication interface 610.

The storage unit 604 can store the software 612. The storage unit 604 can also store user relevant information, such as literature, music, notes, games, or any combination thereof. The storage unit 604 can be a volatile memory, a nonvolatile memory, an internal memory, an external memory, or a combination thereof. For example, the storage unit 604 can be a nonvolatile storage such as non-volatile random access memory (NVRAM), Flash memory, disk storage, or a volatile storage such as static random access memory (SRAM).

The storage unit 604 can include a storage interface 616. The storage interface 616 can be used for communication with any of the functional units in the first device 102. The storage interface 616 can also be used for communication that is external to the first device 102. The storage interface 616 can receive information from another of the functional units or from the external sources, or can transmit information to another of the functional units or to the external destinations.

The storage interface 616 can include different implementations depending on which of the functional units are being interfaced with the storage unit 604. The storage interface 616 can be implemented with technologies and techniques similar to the implementation of the communication interface 610.

For illustrative purposes, the electronic device system 100 is shown with partitions having the user interface 602, the storage unit 604, the control unit 606, and the communication unit 608 although it is understood that the electronic device system 100 can have a different partitions. For example, the software 612 can be partitioned differently such that some or all of its function can be in the storage unit 604, the control unit 606, the communication unit 608, or any combination thereof. The first device 102 can also include other functional units (not shown) or described in this embodiment.

The functional units in the first device 102 can work individually and independently of the other functional units. The first device 102 can work individually and independently from the second device 106 and the communication path 104.

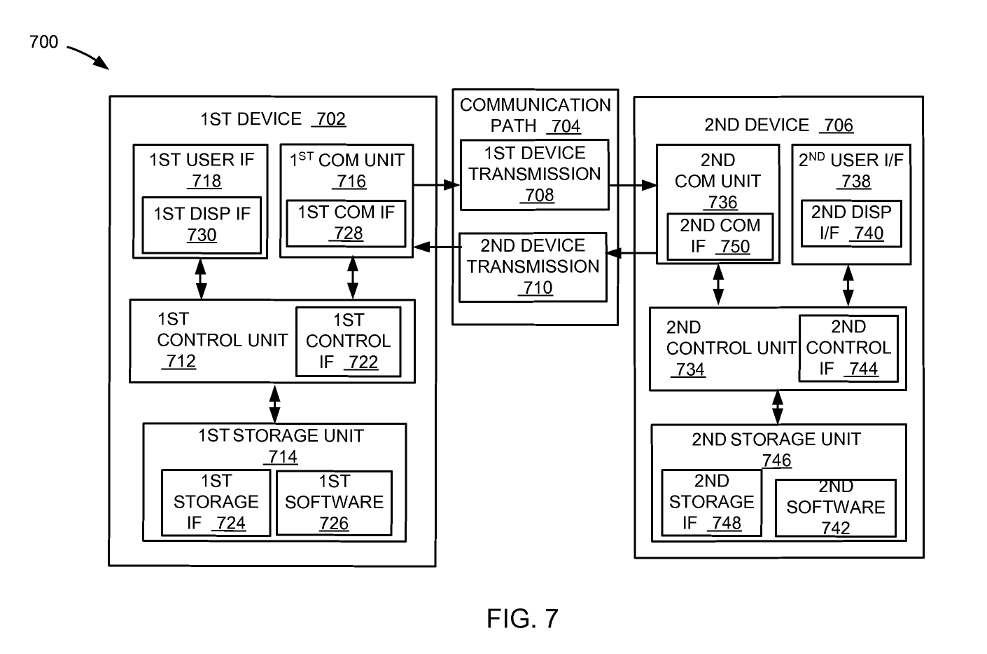

Referring now to FIG. 7, therein is shown an exemplary block diagram of an electronic device system 700 with a gesture processing mechanism in a second embodiment of the present invention. The electronic device system 700 can include a first device 702, a communication path 704, and a second device 706.

The first device 702 can communicate with the second device 706 over the communication path 704. For example, the first device 702, the communication path 704, and the second device 706 can be the first device 102 of FIG. 1, the communication path 104 of FIG. 1, and the second device 106 of FIG. 1, respectively. The screen shot shown on the display interface 202 described in FIG. 2 can represent the screen shot for the electronic device system 700.

The first device 702 can send the display information 204 of FIG. 3 and the graphical area 308 of FIG. 3 with graphical content (not shown) in a first device transmission 708 over the communication path 704 to the second device 706. The second device 706 can display the display information 204 and the graphical area 308 with the graphical content from the first device 702.

For illustrative purposes, the electronic device system 700 is shown with the first device 702 as a client device, although it is understood that the electronic device system 700 can have the first device 702 as a different type of device. For example, the first device 702 can be a server with a touch sensitive display.

Also for illustrative purposes, the electronic device system 700 is shown with the second device 706 as a server, although it is understood that the electronic device system 700 can have the second device 706 as a different type of device. For example, the second device 706 can be a client device with a touch sensitive display.

For brevity of description in this embodiment of the present invention, the first device 702 will be described as a client device and the second device 706 will be described as a server device. The present invention is not limited to this selection for the type of devices. The selection is an example of the present invention.

The first device 702 can include a first control unit 712, a first storage unit 714, a first communication unit 716, and a first user interface 718. The first device 702 can be similarly described by the first device 102.

The first control unit 712 can include a first control interface 722. The first control unit 712 and the first control interface 722 can be similarly described as the control unit 606 of FIG. 6 and the controller interface 614 of FIG. 6, respectively.

The first storage unit 714 can include a first storage interface 724. The first storage unit 714 and the first storage interface 724 can be similarly described as the storage unit 604 of FIG. 6 and the storage interface 616 of FIG. 6, respectively. First software 726 can be stored in the first storage unit 714.

The first communication unit 716 can include a first communication interface 728. The first communication unit 716 and the first communication interface 728 can be similarly described as the communication unit 608 of FIG. 6 and the communication interface 610 of FIG. 6, respectively.

The first user interface 718 can include a first display interface 730. The first user interface 718 and the first display interface 730 can be similarly described as the user interface 602 of FIG. 6 and the display interface 202 of FIG. 6, respectively.

The performance, architectures, and type of technologies can also differ between the first device 102 and the first device 702. For example, the first device 102 can function as a single device embodiment of the present invention and can have a higher performance than the first device 702. The first device 702 can be similarly optimized for a multiple device embodiment of the present invention.

For example, the first device 102 can have a higher performance with increased processing power in the control unit 606 compared to the first control unit 712. The storage unit 604 can provide higher storage capacity and access time compared to the first storage unit 714.

Also for example, the first device 702 can be optimized to provide increased communication performance in the first communication unit 716 compared to the communication unit 608. The first storage unit 714 can be sized smaller compared to the storage unit 604. The first software 726 can be smaller than the software 612 of FIG. 6.

The second device 706 can be optimized for implementing the present invention in a multiple device embodiment with the first device 702. The second device 706 can provide the additional or higher performance processing power compared to the first device 702. The second device 706 can include a second control unit 734, a second communication unit 736, and a second user interface 738.

The second user interface 738 allows a user (not shown) to interface and interact with the second device 706. The second user interface 738 can include an input device and an output device. Examples of the input device of the second user interface 738 can include a keypad, a touchpad, soft-keys, a keyboard, a microphone, or any combination thereof to provide data and communication inputs. Examples of the output device of the second user interface 738 can include a second display interface 740. The second display interface 740 can include a display, a projector, a video screen, a speaker, or any combination thereof.

The second control unit 734 can execute second software 742 to provide the intelligence of the second device 106 of the electronic device system 700. The second software 742 can operate in conjunction with the first software 726. The second control unit 734 can provide additional performance compared to the first control unit 712 or the control unit 606.

The second control unit 734 can operate the second user interface 738 to display information. The second control unit 734 can also execute the second software 742 for the other functions of the electronic device system 700, including operating the second communication unit 736 to communicate with the first device 702 over the communication path 704.

The second control unit 734 can be implemented in a number of different manners. For example, the second control unit 734 can be a processor, an embedded processor, a microprocessor, a hardware control logic, a hardware finite state machine (FSM), a digital signal processor (DSP), or a combination thereof.

The second control unit 734 can include a second controller interface 744. The second controller interface 744 can be used for communication between the second control unit 734 and other functional units in the second device 706. The second controller interface 744 can also be used for communication that is external to the second device 706.

The second controller interface 744 can receive information from the other functional units or from external sources, or can transmit information to the other functional units or to external destinations. The external sources and the external destinations refer to sources and destinations external to the second device 706.

The second controller interface 744 can be implemented in different ways and can include different implementations depending on which functional units or external units are being interfaced with the second controller interface 744. For example, the second controller interface 744 can be implemented with a pressure sensor, an inertial sensor, a microelectromechanical system (MEMS), optical circuitry, waveguides, wireless circuitry, wireline circuitry, or a combination thereof.

A second storage unit 746 can store the second software 742. The second storage unit 746 can also store the relevant information, such as literature, music, notes, games, or any combination thereof. The second storage unit 746 can be sized to provide the additional storage capacity to supplement the first storage unit 714.

For illustrative purposes, the second storage unit 746 is shown as a single element, although it is understood that the second storage unit 746 can be a distribution of storage elements. Also for illustrative purposes, the electronic device system 700 is shown with the second storage unit 746 as a single hierarchy storage system, although it is understood that the electronic device system 700 can have the second storage unit 746 in a different configuration. For example, the second storage unit 746 can be formed with different storage technologies forming a memory hierarchal system including different levels of caching, main memory, rotating media, or off-line storage.

The second storage unit 746 can be a volatile memory, a nonvolatile memory, an internal memory, an external memory, or a combination thereof. For example, the second storage unit 746 can be a nonvolatile storage such as non-volatile random access memory (NVRAM), Flash memory, disk storage, or a volatile storage such as static random access memory (SRAM).

The second storage unit 746 can include a second storage interface 748. The second storage interface 748 can be used for communication between the functional units in the second device 706. The second storage interface 748 can also be used for communication that is external to the second device 706.

The second storage interface 748 can receive information from the other functional units or from external sources, or can transmit information to the other functional units or to external destinations. The external sources and the external destinations refer to sources and destinations external to the second device 706.

The second storage interface 748 can include different implementations depending on which functional units or external units are being interfaced with the second storage unit 746. The second storage interface 748 can be implemented with technologies and techniques similar to the implementation of the second controller interface 744.

The second communication unit 736 can enable external communication to and from the second device 706. For example, the second communication unit 736 can permit the second device 706 to communicate with the first device 702 over the communication path 704.

The second communication unit 736 can also function as a communication hub allowing the second device 706 to function as part of the communication path 704 and not limited to be an end point or terminal unit to the communication path 704. The second communication unit 736 can include active and passive components, such as microelectronics or an antenna, for interaction with the communication path 704.

The second communication unit 736 can include a second communication interface 750. The second communication interface 750 can be used for communication between the second communication unit 736 and other functional units in the second device 706. The second communication interface 750 can receive information from the other functional units or can transmit information to the other functional units.

The second communication interface 750 can include different implementations depending on which functional units are being interfaced with the second communication unit 736. The second communication interface 750 can be implemented with technologies and techniques similar to the implementation of the second controller interface 744.

The first communication unit 716 can couple with the communication path 704 to send information to the second device 706 in the first device transmission 708. The second device 706 can receive information in the second communication unit 736 from the first device transmission 708 of the communication path 704.

The second communication unit 736 can couple with the communication path 704 to send information to the first device 702 in the second device transmission 710. The first device 702 can receive information in the first communication unit 716 from the second device transmission 710 of the communication path 704. The electronic device system 700 can be executed by the first control unit 712, the second control unit 734, or a combination thereof.

For illustrative purposes, the second device 106 is shown with the partition having the second user interface 738, the second storage unit 746, the second control unit 734, and the second communication unit 736, although it is understood that the second device 106 can have a different partition. For example, the second software 742 can be partitioned differently such that some or all of its function can be in the second control unit 734 and the second communication unit 736. Also, the second device 706 can include other functional units not shown in FIG. 7 for clarity.

The functional units in the first device 702 can work individually and independently of the other functional units. The first device 702 can work individually and independently from the second device 706 and the communication path 704.

The functional units in the second device 706 can work individually and independently of the other functional units. The second device 706 can work individually and independently from the first device 702 and the communication path 704.

For illustrative purposes, the electronic device system 700 is described by operation of the first device 702 and the second device 706. It is understood that the first device 702 and the second device 706 can operate any of the modules and functions of the electronic device system 700.

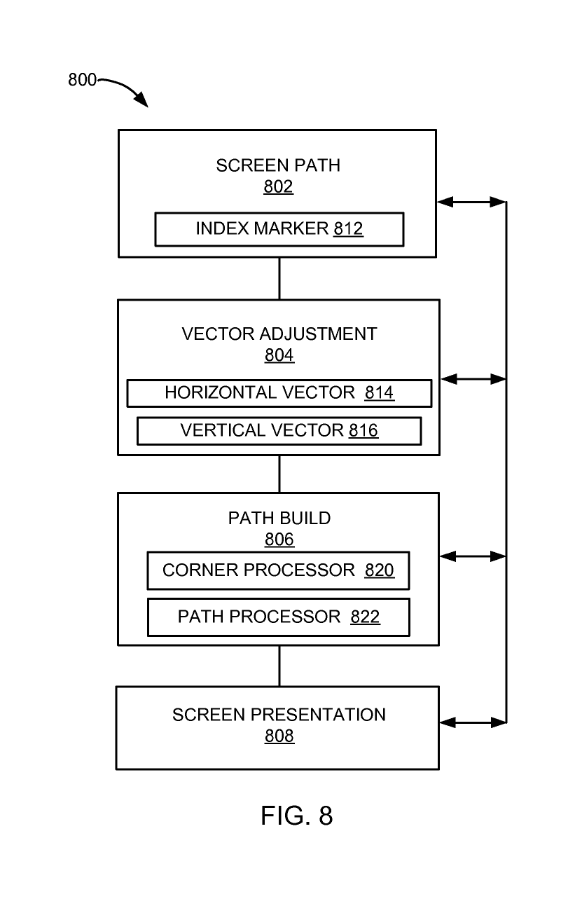

Referring now to FIG. 8, therein is shown an exemplary block diagram of an electronic device system 800 with a gesture processing mechanism in a third embodiment of the present invention. The electronic device system 800 can preferably include a screen path module 802, a vector adjustment module 804, a path build module 806, and a screen presentation module 808.

The screen path module 802, the vector adjustment module 804, the path build module 806, or the screen presentation module 808 can be coupled to one another in any combination. The electronic device system 800, including the screen path module 802, the vector adjustment module 804, the path build module 806, or the screen presentation module 808, can be coupled to any of the functional units of the first device 702 of FIG. 7, the communication path 704 of FIG. 7, or the second device 706 of FIG. 7.

The screen pointer 208 of FIG. 2 in direct contact with the display interface 202 of FIG. 2 can result in a screen interrupt generated by the screen path module 802 to indicate a start of gesture processing. The screen interrupt can be used to reset or initialize the vector adjustment module 804 or the path build module 806.

The screen interrupt can be used by the index marker module 812 of the screen path module 802 to capture coordinates of the home position 222 on the touch sensitive display screen based on locations of the contact sensors. The index marker module 812 can also send the coordinates identifying the home position 222 to the path build module 806 for use within the path build module 806.

Momentary separation of the screen pointer 208 from the display interface 202 results in an abort interrupt sent from the screen path module 802. The abort interrupt can be received and used by the vector adjustment module 804 or the path build module 806 to cancel the gesture processing or wait for another screen interrupt to reset the current gesture processing and to start another gesture process.

The abort interrupt can also be generated as a result of an end of operation indicator from a path processor module 822 or a gesture complete interrupt from the screen presentation module 808. The end of operation indicator is described further below with a detailed description of the path processor module 822. The gesture complete interrupt is described further below with the detailed description of the screen presentation module 808.

The screen path module 802 sends to the vector adjustment module 804 coordinate information from the contact sensors as movement of the screen pointer 208 is detected. The movement can include the raw movement 216 of FIG. 2, the raw movement 406 of FIG. 4, or any other movement of the screen pointer 208 in continued direct contact with the display interface 202 since the start of gesture processing.

The screen path module 802 can be implemented with the electronic device system 700 of FIG. 7. For example, the screen path module 802 can be implemented with the first user interface 718 of FIG. 7, the first control unit 712 of FIG. 7, the first control interface 722 of FIG. 7, the first storage unit 714 of FIG. 7, the second user interface 738 of FIG. 7, the second control unit 734 of FIG. 7, the second controller interface 744 of FIG. 7, the second storage unit 746 of FIG. 7, or a combination thereof.

The vector adjustment module 804 receives and analysis the coordinate information to determine and analyses if there are vertical deviation movements or horizontal deviation movements. If there are no vertical deviation movements or horizontal deviation movements, the coordinate information is forwarded to the path build module 806.

The vector adjustment module 804 includes a horizontal vector module 814 and a vertical vector module 816. In the event of vertical deviation movements, the horizontal vector module 814 can be used to calculate, compensate, and generate adjusted coordinate information to forward to the path build module 806. In the event of horizontal deviation movements, the vertical vector module 816 can be used to calculate, compensate, and generate adjusted coordinate information to forward to the path build module 806.

For example, the vector adjustment module 804 can be implemented with the first user interface 718 of FIG. 7, the first control unit 712 of FIG. 7, the first control interface 722 of FIG. 7, the first storage unit 714 of FIG. 7, the second user interface 738 of FIG. 7, the second control unit 734 of FIG. 7, the second controller interface 744 of FIG. 7, the second storage unit 746 of FIG. 7, or a combination thereof.

The path build module 806 receives the coordinate information or the adjusted coordinate information from the vector adjustment module 804. The path build module 806 generates a perimeter path defined by a series of path coordinates representing a geometric perimeter. The perimeter path can include the path 224 of FIG. 2, the path 424, or a different. The geometric perimeter can include the geometric shaped area 214, the geometric shaped area 402, or a different area having a geometric shape.

The path build module 806 includes a corner processor module 820. The corner processor module 820 calculates and determines the location and placement of some of the path coordinates representing shaped corners of the geometric perimeter defined by the perimeter path.

The path processor module 822 monitors the generation of the path coordinates to verify that the series of the path coordinates are formed in a rotation sequence order representing either a clockwise or a counter clockwise sequential order on the path. Detection of a change in the rotation sequence order, also referred to as the rotational reversals, can be due to a momentary back tracking of movement by the screen pointer 208 or due to sequences of unintended movements of the screen pointer 208 resulting additional shaped corners in path coordinates.

The path build module 806 can compensate for the changes in rotation sequence order by correcting the path coordinates or the additional shaped corners in the path coordinates. The path processor module 822 can optionally generate and send the end of operation indicator to the screen path module 802.

The screen path module 802 detects the end of operation indicator, cancels the gesture processing, and generates the abort interrupt to the vector adjustment module 804 or the path build module 806. The path build module 806 receives the abort interrupt from the screen path module 802 as an acknowledgement to the end of operation indicator.

The path build module 806 also monitors the path coordinates to check for one of the path coordinates matching coordinates of the home position 222 or matching the path coordinates at the pre-defined distance from the coordinates identifying the home position 222 received from the index marker module 812. The pre-defined distance can be used to address ergonomic preferences, such as physical or visual needs of the user.

A region rendered indicator is generated by the path build module 806 and sent to the screen presentation module 808 as a result of the path coordinates matching the pre-defined distance from the coordinates identifying the home position 222. The region rendered indicator is sent to the screen presentation module 808 to indicate that the perimeter path defining the series of path coordinates representing the geometric perimeter is complete.

The path build module 806 stops generation of the perimeter path. The perimeter path information held until the abort interrupt is detected from the screen path module 802.

The path build module 806 can be implemented with the electronic device system 700 of FIG. 7. For example, the path build module 806 can be implemented with the first user interface 718 of FIG. 7, the first control unit 712 of FIG. 7, the first control interface 722 of FIG. 7, the first storage unit 714 of FIG. 7, the second user interface 738 of FIG. 7, the second control unit 734 of FIG. 7, the second storage unit 746 of FIG. 7, or a combination thereof.

The screen presentation module 808 receives the region rendered indicator from the path build module 806. The screen presentation module 808 displays a graphical window area on the touch sensitive display screen based on the perimeter path from the path build module 806. The screen presentation module 808 can display the notation symbol 302 of FIG. 3 on the touch sensitive display screen.

The graphical window area can include the graphical area 308 of FIG. 3, the graphical area 508 of FIG. 5, or another graphical area having a geometric shape different from shapes of the graphical area 308 or the graphical area 508. The screen presentation module 808 generates a gesture complete interrupt to the screen path module 802 to indicate that the gesture processing has been successful and is available for further gesture processing.

The screen presentation module 808 can be implemented with the electronic device system 700 of FIG. 7. For example, the screen presentation module 808 can be implemented with the first user interface 718 of FIG. 7, the first communication unit 716 of FIG. 7, the first control unit 712 of FIG. 7, the first control interface 722 of FIG. 7, the first storage unit 714 of FIG. 7, the communication path 704 of FIG. 7, the second communication unit 736 of FIG. 7, the second user interface 738 of FIG. 7, the second control unit 734 of FIG. 7, the second controller interface 744 of FIG. 7, the second storage unit 746 of FIG. 7, or a combination thereof.

The electronic device system 800 can be partitioned between the first device 702 of FIG. 7 and the second device 706 of FIG. 7. For example, the electronic device system 800 can be partition into the functional units of the first device 702, the second device 706, between the first device 702 and the second device 706, or a combination thereof. The electronic device system 800 can also be implemented as additional functional units in the first device 702, the second device 706, or a combination thereof.

It has been discovered that the screen path module 802, the vector adjustment module 804, the path build module 806, and the screen presentation module 808 of the electronic device system 800 eliminates the delayed processing techniques or reliance on gestures, patterns, stored data, or stored patterns that have been predetermined, previously stored, or preprogrammed.

It has also been discovered that the screen path module 802, the vector adjustment module 804, the path build module 806, and the screen presentation module 808 of the electronic device system 800 produces geometric shaped graphical areas from irregular, shaken, or random deviated movements of the screen pointer 208 with better accuracy and reliability than other touch sensitive displays using stored patterns that have been predetermined, previously stored, or preprogrammed to determine rendition of the screen pointer 208 movements.

The physical transformation of movement of the screen pointer 208, the raw movement 216 detected directly by the contact sensors, the home position 222 identified by initial detection of the screen pointer 208 used to start, end, and validate the formation of the outlined shape results in a visual display of the movement in the physical world, a shape, size, and location of a graphical area on a touch sensitive display screen of the first device 702, the second device 706, or display screens, based on the operation of the electronic device system 800 with notes. As the movement in the physical world occurs, the movement itself creates additional information that is converted back to a path defining a geometric shape and size displayed as the graphical area on the touch sensitive display screen for the continued operation of the electronic device system 800 in the physical world.

Thus, it has been discovered that the electronic device system 800 and the first device 702 or the second device 706 of the present invention furnishes important and heretofore unknown and unavailable solutions, capabilities, and functional aspects for touch sensitive display screens with notes.

The electronic device system 800 describes the module functions or order as an example. The modules can be partitioned differently. Each of the modules can operate individually and independently of the other modules. For example, the path build module 806 and the screen presentation module 808 can be integrated and combined with the vector adjustment module 804 to form a single module.

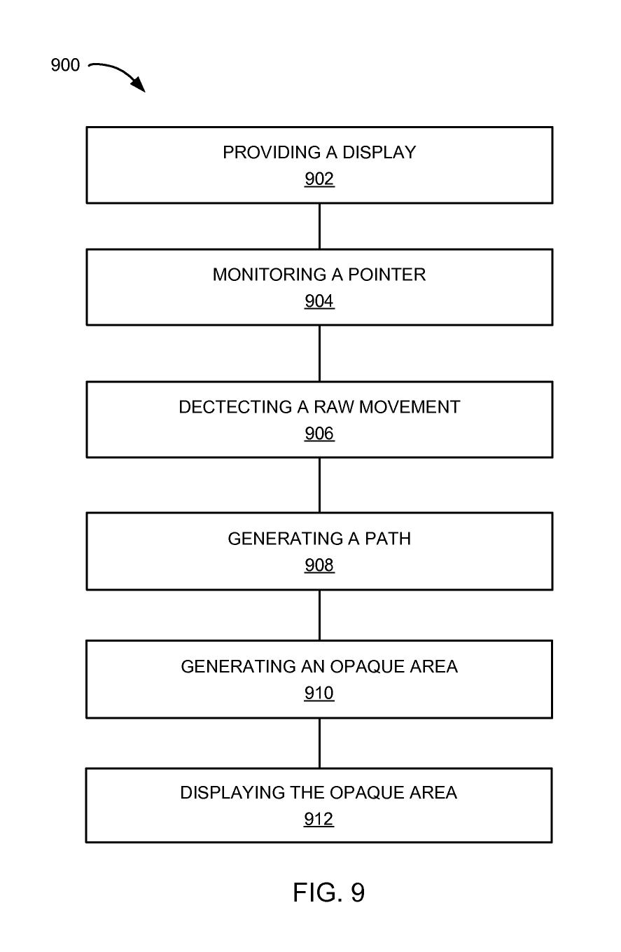

Referring now to FIG. 9, therein is shown a flow chart of a method 900 of operation of an electronic device system in a further embodiment of the present invention. The method 900 includes: providing a display interface in a block 902; monitoring a screen pointer in direct contact with the display interface in a block 904; detecting a raw movement having movement deviations on the display interface with the screen pointer for forming a geometric shaped area in a block 906; generating a path based on the raw movement and compensated for movement deviations in the raw movement to define a perimeter of the geometric shaped area in a block 908; generating a graphical area having a geometric shape defined by the path in a block 910; and displaying the graphical area in the display interface in a block 912.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization.

Another important aspect of the present invention is that it valuably supports and services the historical trend of reducing costs, simplifying systems, and increasing performance.

These and other valuable aspects of the present invention consequently further the state of the technology to at least the next level.

While the invention has been described in conjunction with a specific best mode, it is to be understood that many alternatives, modifications, and deviations will be apparent to those skilled in the art in light of the aforegoing description. Accordingly, it is intended to embrace all such alternatives, modifications, and deviations that fall within the scope of the included claims. All matters hithertofore set forth herein or shown in the accompanying drawings are to be interpreted in an illustrative and non-limiting sense.

What is claimed is:

1. A method of operation of an electronic device system comprising:
providing a display interface;
monitoring a screen pointer in direct contact with the display interface;
detecting a raw movement having movement deviations on the display interface with the screen pointer for forming a geometric shaped area;
generating a path based on the raw movement and compensated for movement deviations in the raw movement to define a perimeter of the geometric shaped area;
generating a graphical area having a geometric shape defined by the path; and
displaying the graphical area in the display interface.

2. The method as claimed in claim 1 wherein generating the path includes generating the path to compensate and to correct rotational reversals.

3. The method as claimed in claim 1 wherein displaying the graphical area includes displaying a notation symbol in the display interface.

4. The method as claimed in claim 1 wherein detecting the raw movement includes detecting the raw movement with the screen pointer in continued contact with the display interface.

5. The method as claimed in claim 1 wherein displaying the graphical area includes displaying the graphical area with respect to coordinate positions of the display interface.

6. A method of operation of an electronic device system comprising:
providing a display interface having a touch sensitive display screen;
monitoring a screen pointer in direct contact with touch sensitive display screen;
detecting a raw movement having movement deviations on the touch sensitive display screen with the screen pointer for forming a geometric shaped area;
generating a path based on the raw movement and compensated for movement deviations in the raw movement to define a perimeter of the geometric shaped area;
generating a graphical area having a geometric shape defined by the path; and
displaying display information under the graphical area in the touch sensitive display screen.

7. The method as claimed in claim 6 wherein generating the path includes generating the path to compensate and to correct rotational reversals due to additional shaped corners from the raw movement.

8. The method as claimed in claim 6 wherein displaying the graphical area includes displaying a notation symbol in the touch sensitive display screen to indicate successful generation of the graphical area.

9. The method as claimed in claim 6 wherein detecting the raw movement includes detecting the raw movement with the screen pointer in continued contact with the touch sensitive display screen.

10. The method as claimed in claim 6 wherein displaying the graphical area includes displaying the graphical area with respect to coordinate positions on a display perimeter of the display interface.

11. An electronic device system comprising:
a user interface for providing a display interface;
a screen path module for monitoring a screen pointer in direct contact with the display interface;
a vector adjustment module for detecting a raw movement having movement deviations on the display interface with the screen pointer for forming a geometric shaped area;
a path build module coupled to the vector adjust module for generating a path based on the raw movement and compensated for movement deviations in the raw movement to define a perimeter of the geometric shaped area;
a control unit coupled to the path build module for generating a graphical area having a geometric shape defined by the path; and
a screen presentation module for displaying the graphical area in the display interface.

12. The system as claimed in claim 11 wherein the path build is for generating the path to compensate and to correct rotational reversals.

13. The system as claimed in claim 11 wherein the screen presentation module is for displaying a notation symbol in the display interface.

14. The system as claimed in claim 11 wherein the vector adjustment module is for detecting the raw movement with the screen pointer in continued contact with the display interface.

15. The system as claimed in claim 11 wherein the screen presentation module is for displaying the graphical area with respect to coordinate positions of the display interface.

16. The system as claimed in claim 11 further comprising a communication unit coupled to the display interface for display information under the graphical area.

17. The system as claimed in claim 16 wherein the path build is for generating the path to compensate and to correct rotational reversals due to additional shaped corners from the raw movement.

18. The system as claimed in claim 16 wherein the screen presentation module is for displaying a notation symbol in the touch sensitive display screen to indicate successful generation of the graphical area.

19. The system as claimed in claim 16 wherein the vector adjustment module is for detecting the raw movement with the screen pointer in continued contact with the touch sensitive display screen.

20. The system as claimed in claim 16 wherein the screen presentation module is for displaying the graphical area with respect to coordinate positions on a display perimeter of the display interface.
